(19) United States
(12) Patent Application Publication
(10) Pub. No.: US 2023/0242063 A1
(43) Pub. Date: Aug. 3, 2023

(54) AUTOMOTIVE RESTRAINING BELT AND PROTECTIVE DEVICE THEREFOR

(71) Applicant: Nick Smart, Tampa, FL (US)

(72) Inventor: Nick Smart, Tampa, FL (US)

(21) Appl. No.: 18/105,149

(22) Filed: Feb. 2, 2023

Related U.S. Application Data
(60) Provisional application No. 63/305,709, filed on Feb. 2, 2022.

(51) Int. Cl. B60R 22/10; A01K 1/06; B60R 22/34; B60R 22/16

(52) U.S. Cl. CPC B60R 22/10; A01K 1/0613; B60R 22/34; B60R 22/16

(57) ABSTRACT

The present invention provides a single point restraining system for pets. The system is designed to be used with an automotive safety belt restraining system. A first end of the system is a housing having tensioning components therein with the housing having a standard male seat belt connector. An extendable and retractable belt is anchored within the housing, the belt having a connecting end formed by looping a length of material around a male connector. A retraction limiting component is attached to the connecting end of the belt to prevent damage thereto. The housing can be attached to a seat belt receiver and the belt may have a collar attachment for connection to a pet collar.

### CROSS REFERENCE TO EARLIER FILED APPLICATIONS

This application claims priority to Provisional Application No. 63/305,709 filed on Feb. 2, 2022.

### FIELD OF THE INVENTION

The present invention relates to restraining belts and harnesses. More particularly, it relates to a restraining belt for pets useful in an automotive environment.

### BACKGROUND OF THE INVENTION

Safety belt restrainers, car seats, and other devices have been improved in recent years as crash data clearly indicate that some restraint is necessary even for small children and pets. Small children, and pets in particular, are difficult to restrain because of their small size. Pets have the additional problem in that they are not shaped like humans so the restraining device or belts must be modified to conform to the shape of the pet to be restrained.

However, proper restraint of pets in vehicles presents many challenges. For example, finding an easy secure attachment for a pet leash can be difficult. While all new automobiles are provided with safety restraints that are designed to accommodate humans, they are not suitable for restraining pets as discussed above. In addition, if a leash attachment point is found, there will inevitably be a certain amount of slack in the leash in order to provide the pet with a humane amount of mobility. In an accident or abrupt stop, however, this slack will allow the pet to be projected forward and then suddenly jerked to a stop when the slack in the leash has run out. This can lead to serious injury to the pet in a hard braking scenario.

Most prior art restraint devices for pets are either multi-point harness devices, or belts or straps connected in some way to an existing vehicular seat belt system. These devices do not typically have tensioning systems and thus cannot manage the slack when the pet moves closer to the anchoring point of the device. Of course, if there is slack during an impact the pet will not be restrained. Accordingly, there remains a need for an apparatus that can conveniently and safely restrain a pet while traveling.

A problem that occurs with restraining belts used for pets is that the end of the belt or “webbing” attached to the pet collar is typically looped back onto itself by way of stitching. This looped back portion is then slid into the tensioner housing repeatedly during normal use. This action can be greatly exacerbated by a pet. Abrasion of the stitching can cause the stitching to become frayed with the result that the belt can be compromised over time, no longer able to provide a proper amount of restraining force.

### SUMMARY OF THE INVENTION

The present invention provides a single point restraining device for pets. The device is designed to be used with an automotive safety belt restraining system. A first end of the system is a housing having tensioning components therein with the housing having a standard male seat belt connector. An extendable and retractable belt is anchored within the housing, the belt having a connecting end formed by looping a length of material around a male connector. A retraction limiting component is attached to the connecting end of the belt to prevent damage thereto. The housing can be attached to a seat belt receiver and the belt may have a collar attachment for connection to a pet collar.

It is an object of the invention to provide an improved single point restraining device for pets.

It is another object of the invention to provide an improved single point restraining device for pets that can be used with a conventional three point automotive seat belt system.

It is an object of the invention to provide an improved single point restraining device for pets attachable to a standard seat belt receiver.

It is an object of the invention to provide an improved single point restraining device for pets having a retraction limiting component is attached to the connecting end.

It is an object of the invention to provide a retraction limiting component to a standard seat belt assembly attachable to anchors and tethers positioned within a vehicle.

It is an object of the invention to provide an improved single point restraining device for pets having a tear away feature.

### BRIEF DESCRIPTION OF THE DRAWINGS

FIG. 1 shows the device of the present invention in it's intended environment.

FIG. 2 shows a plan view of the restraining belt apparatus of the invention.

FIG. 3 shows a plan view of a first embodiment of the restraining belt apparatus of the invention.

FIG. 4 shows a plan view of a second embodiment of the restraining belt apparatus of the invention.

FIG. 5 shows a plan view of a third embodiment of the restraining belt apparatus of the invention.

FIG. 6 shows a perspective view of a car seat illustrating attachment points for the embodiment of FIG. 5.

FIG. 7 shows a side view of a car seat illustrating attachment points for the embodiment of FIG. 5.

FIG. 8 shows a perspective view of an anti-twist component used with the apparatus.

FIG. 9 shows a perspective view of a fourth embodiment of the restraining belt apparatus of the invention.

### DETAILED DESCRIPTION OF THE PREFERRED EMBODIMENTS

The present invention is a safety device for harnessing a pet within an automotive environment. The device, generally indicated by the numeral 10, includes an extendable strap or belt 12 wound about a reel contained within a housing 20. The belt 12 is preferably made of a non-elastic woven material such as polyester. A tensioning and retracting mechanism is mechanically coupled to said reel and secured within the housing, the mechanism operating to control extension and retraction of the belt 12.

The housing 20 containing the reel and belt 12, the belt 12 having a male connector or fastener 22 affixed to its distal end, is configured for attachment to a pet collar as will be described in more detail below. The tensioner component of the tensioning and retracting mechanism may use a centrifugal clutch or pendulum lock mechanism while the retractor may use a spring retractor mechanism, but any mechanism familiar to those of skill in the art may be used here. The self-tensioning mechanism may be, for example, a centrifugal clutch mechanism or a pendulum lock mechanism. The fastener 22 may be a clip or similar type of fastener for attachment to a pet collar or pet harness in the well known manner. Alternatively, any durable, easily released attachment means may be used such as a button or hook. The load attached to fastener 22 may be a pet, like a dog or a cat, and the fastener 22 may attach to a jacket, pet harness, sweater, or other article of clothing or accessory affixed to the animal. The retractor is spring loaded so as to apply a constant force to wind the belt 12 on the reel to eliminate slack and provide some restraining force on the load, and the tensioner may lock the reel to fix an extended length of the belt 12 upon sudden movement to secure the load. The housing 20, the tensioning and retracting mechanism, the reel, and the fastener 22 may be comprised of any suitable rigid material such as hard plastic or metal.

According to the invention, a device 10 for securing a pet within a vehicle using an extendable belt 12, a tensioning and retracting mechanism, a reel for winding said belt 12, a fastener 22, and an anchoring element 42 for securing said device is provided. The fastener 22 is at a first or distal end of the belt 12 and the anchoring element 42 is affixed to and extends from the belt housing 20, the anchoring element 42 having a connector extending in generally the opposite of the direction of extension of the extendable belt 12. It should be noted that the length of the belt 12 cannot be more than about 3 feet as any length greater than this will allow the pet to wander or move to an adjacent seating area within the vehicle thereby making restraint in an accident scenario impossible as there will be too much “play” in the belt 12 to provide effective restraint. In accordance with a key aspect of the invention, means are provide to ensure reliable operation of the device 10 by limiting wear and tear as described in detail below.

The retractor of the retraction and tensioning mechanism may be configured to apply a force to wind the belt 12 on the reel and this force may be adjusted to be stronger or weaker depending on the strength of the pet. Adjustment mechanisms of this type are known to those of skill in the art and can take many forms. Alternatively, the device 10 may have a tensioning force commensurate with the size of the pet so that, for example, a large dog can still move freely but will be held back with sufficient force to discourage excessive movement, this force being determined by trial and error during the manufacturing process. The tensioner may be configured to lock the reel to fix an extended length of the belt 12 and may also be configured to pretension and lock the reel in response to a trigger such as a sudden movement.

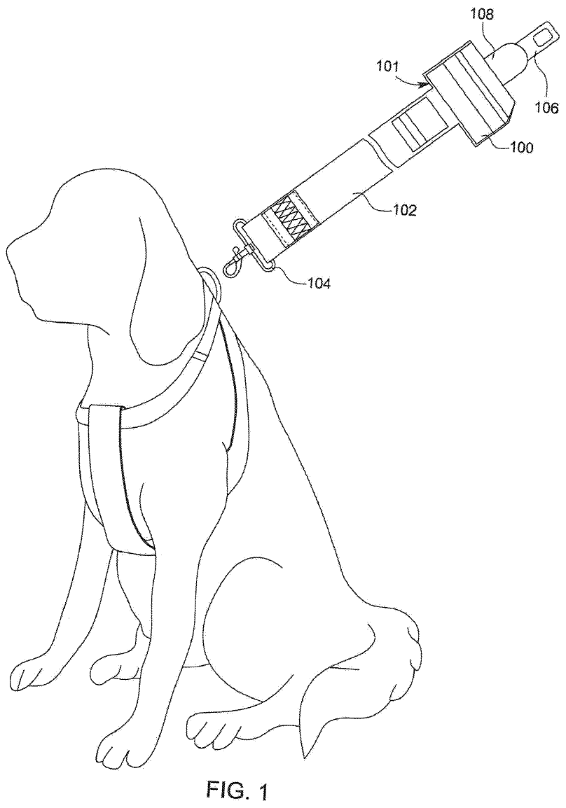

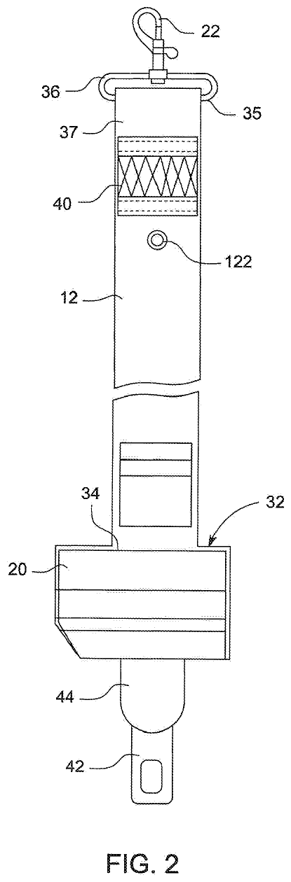

Referring now FIGS. 1 to 4 various embodiments of a self-tensioning and retracting pet safety belt device 10 formed in accordance with the invention is shown. The device 10, can permit a dog or other pet to move freely within a vehicle while also securing the dog or other pet in the event of a collision or other rapid change in acceleration. FIG. 1 shows the inventive device 10 positioned for use on a pet positioned on the vehicle seat 29. It can be seen that the pet is wearing a harness, but the device 10 can easily be attached to a collar or article of clothing.

The seat belt 12 may be made from any appropriate relatively inelastic material such as, for example, polyester or nylon seat belt webbing.

The seat belt 12 may be attached at the proximal end 32 to a reel contained within the housing 20, and may be wound around the reel within the housing 20. The self-tensioning mechanism and retracting mechanisms may be incorporated into or attached to the reel and are securely affixed within the housing 20. The housing 20 includes an opening 34, which is a slit or slot large enough for the belt 12 to pass through with minimal clearance, that may allow a length of the seat belt 12 to be selectively extended from the housing 20 in the well known manner.

At a distal end of the seat belt 12, a short length is extended from the housing 20, and inserted under a looping bar 35 of collar adapter 36 and then sewn back into itself so as to create a loop 37 securing the seat belt 12 to the collar adapter 36, the loop 37 and collar adapter 36 cooperating to prevent the seat belt 12 from retracting completely into the housing 20. The collar adapter 36 may be any appropriate adapter such as, for example, a clip, hook, button loop, or other adapter suitable for connecting the seat belt 12 to a pet collar.

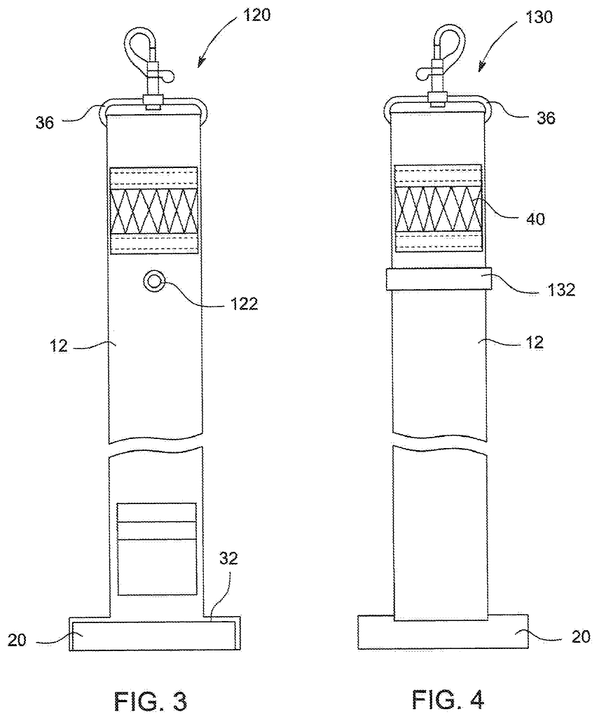

The sewn area 40 of the loop is subjected to wear and tear as it passes through the slit 34 when retracting and extending, as this is the thickest portion of the belt due to the overlap. This is a common problem with pets as they are much more active than people, causing many instances of retraction and extension leading to fraying of the sewn area 40. This can ultimately weaken this area and reduce the effective restraining power of the belt 12 as the frayed area can fail. This potential to fail may not be apparent to the user and thus needs to be obviated. To this end, two embodiments of retraction limiting components are shown in FIGS. 3 and 4. The first embodiment 120 in FIG. 3 uses a button 122 which is raised or sufficiently thick to prevent the sewn area 40 of the belt 12 from sliding into the housing 20. Specifically, button 122 must be made too large to fit through slit 34. The second embodiment 130 uses a bar 132 also having dimensions preventing retraction of the sewn area 40 past the slit 34. Both button 122 and bar 132 are securely attached to the belt 12 using any suitable means for securing such as fasteners or adhesives. It should be noted that this retraction limiting arrangement can be implemented with any seat belt assembly having a retractable belt.

While the present invention allows a user to restrain a pet safely, it can be appreciated that with any restraint there is a possibility of the pet choking or otherwise being injured because of the position of the pet relative to the restraint at the moment of impact. Accordingly, the sewn area 40 of the loop can be designed with a tear away feature. This feature would cause the belt 12 to rupture at the sewn area 40 when a predetermined amount of force is applied. The amount of force can be variable, that is the sewn area 40 may be made to tear easily for small pets, with much more force required for larger pets. It should be noted that the belt 12 does not tear completely, it tears partially to essentially lengthen the deceleration time to reduce the restraining force applied to the pet. A number of methods for creating a tear away portion for the belt 12 are known to those of skill in the art, such as connecting the sewn area 40 to the rest of the belt 12 by stitching 41, the stitching having a predetermined tear force.

The self-tensioning and retracting pet safety belt device 10 may further include an anchoring element 42, which may be attached to the housing 20 on an opposite side from the exit of the seat belt 12. The anchoring element 42 extends from a projection 44 formed in the rear of housing 20 and is preferably formed as part of the housing 20 or may alternatively be securely affixed thereto. The anchoring element 42 may be any connector suitable for plugging into a standard vehicle seat belt receiver.

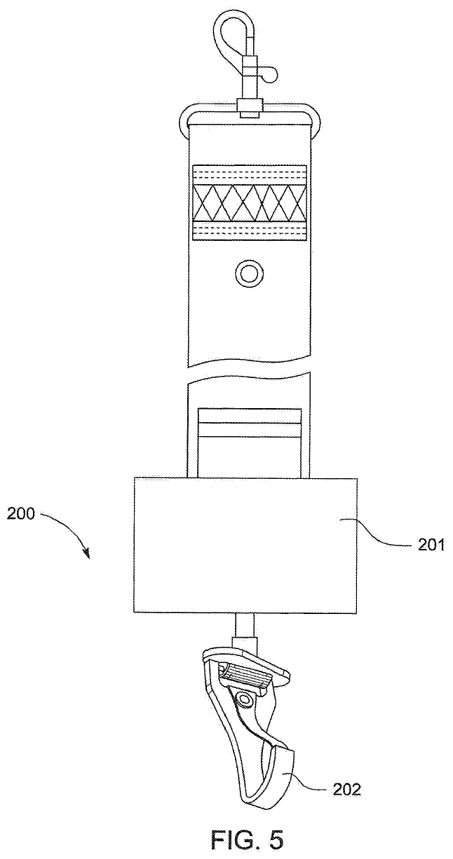

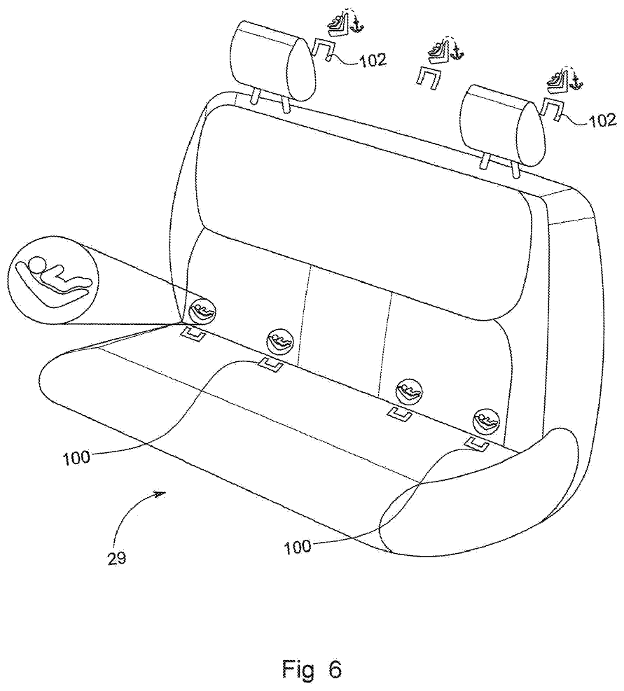

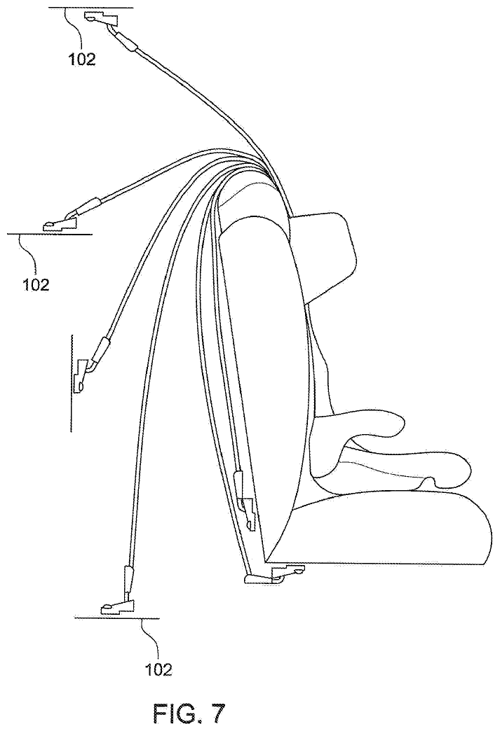

Referring now to FIGS. 5-7, another alternative embodiment is shown. In this embodiment, the lower anchors and tethers already provided in most late model vehicles are used in lieu of the seat belt receiver to anchor the device. It can be seen that the lower anchors 100 are embedded in the seat 29 between the backrest and lower seat cushion and that the tethers 102 are positioned variously depending upon the individual vehicle.

Referring now particularly to FIG. 7, it can be seen that there are various tethers 102 or attachment points, the position of which is variable depending upon the make and model of the vehicle. It should be noted here that since there are multiple attachment points (anchors 100, tethers 102, and seat belt receivers) the user has many options for attaching the device 10.

As shown in FIG. 5, the device 200 can be modified to latch onto anchors 100 or tethers 102 as per the user's discretion. Accordingly, with this configuration, the pet can be secured from any of several attachment points, which gives the user the ability to restrain virtually any pet. Of course, one or more devices 200 may be used with a pet harness having multiple attachment points so that the possibility of choking or other injury can reduced by simply picking one or more attachment points within the vehicle to attach to one or more of the multiple attachment points on the harness. Latching of the device 200 is accomplished by way of hook 202, extending from the rear of the housing 201 containing the reel and belt 12. It can be appreciated that the hook 202 can be replaced with a carabiner clip or other suitable releasable fastener as can be appreciated by one of skill in the art.

In operation, a user may first insert the anchoring element 42 into a vehicle seat belt receiver in their vehicle as they would a standard seat belt. Alternatively, the user may attach device 200 to one of the attachment points 100, 102 within the vehicle. The user may then connect the collar adapter 36 clip or other attachment to a collar or pet harness being worn by a pet within the vehicle as they would a standard leash as can be seen in FIG. 1. The pet may then move around within the vehicle and the seat belt 12 may be unwound or extended from the housing 20 as needed. As the pet moves closer to the housing 20 the retracting mechanism of the device 10 may shorten the exposed length of the seat belt 12. In the event of a sudden or rapid deceleration of the vehicle the self-tensioning mechanism may activate to prevent the pet from being thrown forward within the vehicle.

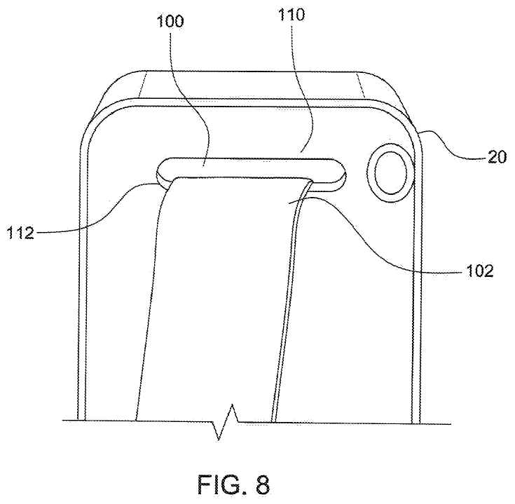

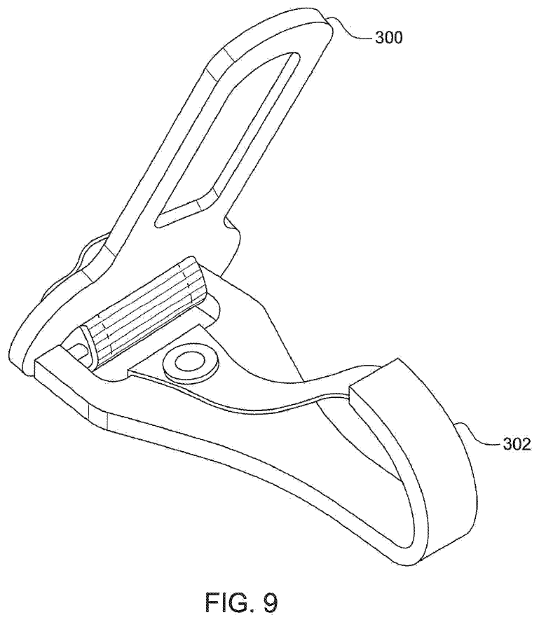

Referring now to FIG. 8, an anti-twist component is shown. The component, 100, is a metal bar which spans the receiving opening 102 of the housing 20 (or any seat belt retractor housing), the housing 20 shown from the inside to illustrate feeding of the belt 12. As is well known, the belt 12 passes through the opening 102 as it is extended. The belt 12 can become twisted when being extended or retracted as there is sufficient space for the belt to fold over on itself while within the opening. A twisted belt 12 is hazardous and may not function properly in an impact situation. The metal bar 100 is positioned approximately halfway between top 110 and bottom 112 edges of the opening. The bar 100 reduces the vertical height of the opening 102 to the point that the belt 12 cannot twist or fold over. This arrangement can be used for any standard seat belt receiver.

Referring now to FIG. 9, an alternative embodiment for the anchoring element 42 extending from the housing 20 is shown. This embodiment provides an alternative connecting end arrangement for the apparatus 10. In lieu of a single male connector such as anchoring element 42 a pair of male connectors 300, 302 are connected to housing 20. This gives the user the option of selecting a standard seat belt receiver or any of the several attachment points (anchors and tethers) as discussed above for attaching the device 10 within the vehicle.

Any variations and any combinations of the above teachings are also intended to be covered by this patent application.

I claim:

1. A safety device for restraining a pet within a vehicle having a seat belt receiver, comprising:
a belt having a fastener at a first end, said belt contained within a housing having an anchoring element positioned thereon;
a tensioner, a reel for winding said belt, and a retractor contained within said housing, the belt having a retraction limiting component thereon; and wherein the fastener is attached to a load or to a coupling attached to the load to secure the load, and the anchoring element is attached within said receiver.

2. The device of claim 1 wherein said belt is positioned about a portion of said fastener to form a loop, the loop including an overlap which secured by way of a sewn area.

3. The device of claim 2 wherein said retraction limiting component is positioned on the belt proximate to said sewn area.

4. The device of claim 2 wherein said housing includes an opening having a predetermined size for the belt to extend therethrough, said retraction limiting component having at least a dimension exceeding said predetermined size so that said sewn area cannot be retracted into said housing.

5. The device of claim 1 wherein said retraction limiting component has a button shape.

6. The device of claim 1 wherein said retraction limiting component has an elongated rectangular shape.

7. The device of claim 1 wherein said anchoring element comprises two different male connectors, where one of said connectors can be inserted into a standard seat belt receiver.

8. The device of claim 7 where one of said male connectors can be attached to anchors or tethers positioned within said vehicle.

8. A safety device for restraining a pet within a vehicle, said vehicle having a seat belt receiver and at least one anchor and tether, the device comprising:
a belt having a fastener at a first end, said belt contained within a housing having an anchoring element and a latching element positioned thereon;
a tensioner, a reel for winding said belt, and a retractor contained within said housing; and wherein the fastener is attached to a load or to a coupling attached to the load to secure the load, and the anchoring element is attached within said receiver.

9. The device of claim 1 wherein said latching element is attached to said at least one anchor.

10. A safety device for restraining a pet within a vehicle having a seat belt receiver and a series of anchors and tethers, the device comprising:
a belt having a fastener at a first end, said belt contained within a housing having at least one anchoring element positioned thereon;
a tensioner, a reel for winding said belt, and a retractor contained within said housing, the belt having a retraction limiting component thereon; and wherein the fastener is attached to a load or to a coupling attached to the load to secure the load, and the anchoring element is attached within said receiver or one of said anchors or tethers.

11. The device of claim 10 wherein said housing includes an opening from which said belt extends, said opening including an anti-twist element to prevent twisting of said belt.

12. The device of claim 8 wherein said anchoring element comprises two different male connectors, where at least one of said connectors can be inserted into a standard seat belt receiver.

13. The device of claim 12 wherein one of said male connecters is attachable to an anchor.

14. The device of claim 10 wherein said belt has a tear away feature.
